(19) United States
(12) Patent Application Publication
(10) Pub. No.: US 2015/0379962 A1
(43) Pub. Date: Dec. 31, 2015

(54) MOVING WALKWAY HAVING TRANSPARENT DISPLAY BOARDS

(71) Applicants: Ji Hyun JUNG, Gyeonggi-do (KR); G-SMATT CO., LTD., Pyeongtaek-si, Gyeonggi-do (KR)

(72) Inventors: Ji Hyun JUNG, Gyeonggi-do (KR); Ho Joon LEE, Seoul (KR)

(21) Appl. No.: 14/768,211

(22) PCT Filed: Jan. 23, 2014
(86) PCT No.: PCT/KR2014/000669

§ 371 Date: Aug. 14, 2015

(30) Foreign Application Priority Data
Feb. 15, 2013 (KR) 10-2013-0016371

(51) Int. Cl. G09G 5/10

(52) U.S. Cl. CPC G09G 5/10; G09G 2300/04

(57) ABSTRACT

The present invention relates to a moving walkway having transparent display boards, and more particularly to a moving walkway having transparent display boards, which comprises transparent display boards supported by one or more posts spaced from each other at both sides of the moving walkway having a footplate extending in one direction, wherein the transparent display boards can uniformly supply driving voltage applied to a light-emitting device within a predetermined range by adjusting the width and length of a pattern, so that a plurality of light sources mounted on the transparent display boards can emit light with a uniform intensity.

### TECHNICAL FIELD

The present invention relates, in general, to moving walkways having transparent electronic display boards and, more particularly, to a moving walkway which is installed in an airport or department store and includes transparent electronic display boards that are provided on opposite sides of footplates and display advertising for the promotion of products, videos for other purposes, etc.

### BACKGROUND ART

Given their very large internal spaces, airports have a plurality of escalators and moving walkways for the ease of movement of pedestrians.

Moving walkways, along with escalators, are representative conveyor transport devices which are becoming increasingly common. For continuous one-way transportation performance, escalators and moving walkways are superior to elevators. Therefore, escalators and moving walkways are widely used as mass transportation devices for use in low-rise applications such as department stores, airports, subway stations, etc.

Conventional moving walkways are configured such that planar footplates are operated by the power of a drive unit so as to enable a large number of pedestrians, who stand or walk on the footplates, to move. Typically, panels are installed on respective opposite sides of the footplates. A separate hand rail is provided on each panel.

Such conventional moving walkways are mainly focused on the safety and convenience of users, and a representative example thereof was proposed in Korean Patent Unexamined Publication No. 2010-0137708.

The conventional moving walkway of No. 2010-0137708 gives importance to a technique of controlling the operation of footplates for convenience in movement of users and depending on whether a user is present on the footplates. However, this conventional moving walkway cannot provide various other services for the users. Thus, users may be bored on the moving walkway if they must move on the moving walkway for a long time because the moving walkway in a large airport or department store is comparatively long. Therefore, with regard to this, there is the need to improve convenience for users.

### DISCLOSURE

### Technical Problem

Accordingly, the present invention has been made keeping in mind the above problems occurring in the prior art, and an object of the present invention is to provide a moving walkway in which transparent electronic display boards are installed upright on opposite sides of footplates and output various videos, thus making it possible for users who move on the moving walkway to relieve tedium, and providing various convenient services to the users.

Another object of the present invention is to provide a moving walkway which is configured such that connection patterns, which are installed in transparent electronic display boards to supply power to light-emitting elements, have different widths depending on the sheet resistances and lengths of transparent electrodes, whereby the light-emitting elements can uniformly output light.

### Technical Solution

The present invention provides a moving walkway having transparent electronic display boards. The moving walkway includes footplates which are connected to each other in one direction. The transparent electronic display boards are supported by posts, which are disposed on opposite sides of the footplates at positions spaced apart from each other. Each transparent electronic display board is configured such that the drive voltages applied to light-emitting elements can be uniformly controlled by adjusting the widths and lengths of connection patterns. Thereby, a plurality of light sources installed on the transparent electronic display board can emit light with uniform intensity.

### Advantageous Effects

In a moving walkway having transparent electronic display boards according to the present invention, transparent electronic display boards which can output images or videos are installed in lieu of transparent panels, which are used as handles to support users, thus making it possible for users who move on the moving walkway to relieve tedium. Furthermore, the transparent electronic display board can provide information, for example, boarding information in an airport, thereby improving user convenience.

Moreover, in each transparent electronic display board of the moving walkway, the light output of light-emitting elements can be made uniform by means of adjusting the widths of connection patterns connected to light-emitting elements of the transparent electronic display board. Therefore, the transparent electronic display board can embody more precise and clean high-quality images or videos.

### DESCRIPTION OF DRAWINGS

FIG. 1 is a perspective view illustrating a moving walkway having a transparent electronic display board according to the present invention;

FIG. 2 is a block diagram illustrating the moving walkway having the transparent electronic display board according to the present invention;

FIG. 3 is a view showing the transparent electronic display board of the moving walkway according to the present invention;

FIG. 4 is a view showing a light-emitting element of the transparent electronic display board of the moving walkway according to the present invention;

FIG. 5 is a view showing a first comparative example of the transparent electronic display board of the moving walkway according to the present invention;

FIG. 6 is a view showing a first experimental example of the transparent electronic display board of the moving walkway according to the present invention;

FIG. 7 is a view showing a second comparative example of the transparent electronic display board of the moving walkway according to the present invention; and

FIG. 8 is a view showing a second experimental example of the transparent electronic display board of the moving walkway according to the present invention.

### BEST MODE

In order to accomplish the above object, the present invention includes the following embodiments.

A moving walkway having a transparent electronic display board according to an embodiment of the present invention includes: a plurality of footplates connected to each other and configured to move in one direction; and transparent electronic display boards installed on respective opposite sides of the footplates, with a support panel installed on an upper surface of each of the transparent electronic display boards, each of the transparent electronic display boards being fixed under the corresponding support panel and outputting a picture including a text, a symbol, an image, or a video. Each of the transparent electronic display boards includes: one or more light-emitting elements fixed on at least one surface of transparent plates, the transparent plates being spaced apart from each other and adhered to each other by transparent resin charged into a space between the transparent plates; transparent electrodes formed by conductive material applied to the transparent plates, the transparent electrodes applying power to the light-emitting elements; and connection patterns extending different lengths from the transparent electrodes and transmitting electrical signals to the light-emitting elements. The widths of the connection patterns are increased as the lengths of the connection patterns connected to the light-emitting elements are increased.

In another embodiment, the width of each of the connection patterns may be calculated from Equations 1 and 2,

L (mm)/W (mm)×sheet resistance (Ω) of transparent electrode=resistance (Ω) of etched area (Equation 1)

rated voltage (V)/resistance (kΩ) of etched area=I (mA) (Equation 2)

where, L denotes the length of the connection pattern, W denotes the width of the connection pattern, the sheet resistance of the transparent electrode refers to a sheet resistance of the transparent electrode itself, the rated voltage is a voltage applied to the transparent electronic display board, I denotes a current applied from the connection pattern to the light-emitting element, and the resistance of the etched area denotes a resistance per unit area of the connection pattern formed by etching on the transparent electrode.

In a further embodiment, the light-emitting element may include one or more anode electrodes and a cathode electrode that are connected to the respective connection patterns. The connection patterns may comprise: one or more connection patterns formed by etching on the transparent electrodes and connected to the respective anode electrodes; and a cathode connection pattern connected in common to cathode electrodes formed on the respective light-emitting elements.

In yet another embodiment, in each of the transparent electronic display boards, the cathode connection pattern and the connection patterns may respectively comprise connection terminals successively extending from at least one of upper, lower, left and right edges of the transparent plates, the connection terminals being connected to transparent conductive tape. Of the connection terminals, the connection terminal of the cathode connection electrode may be disposed at an uppermost position, and the connection terminals of the connection patterns may be successively disposed below the connection terminal of the cathode connection pattern.

In still another embodiment, the connection patterns may be respectively connected to the anode electrodes of each of the light-emitting elements, wherein at least one of the connection patterns is spaced apart from another of the connection patterns by the cathode connection pattern disposed therebetween.

In still another embodiment, the light-emitting elements may be arranged in a horizontal or vertical direction, wherein for each of the light-emitting elements, the number of connection patterns may be equal to the number of anode electrodes of the light-emitting element.

### MODE FOR INVENTION

Hereinafter, a preferred embodiment of a moving walkway having a transparent electronic display board according to the present invention will be described in detail with reference to the attached drawings.

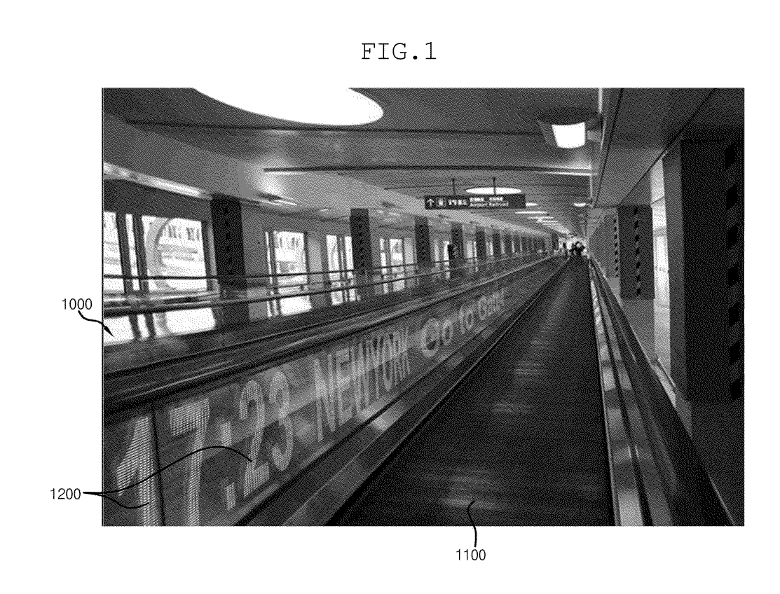

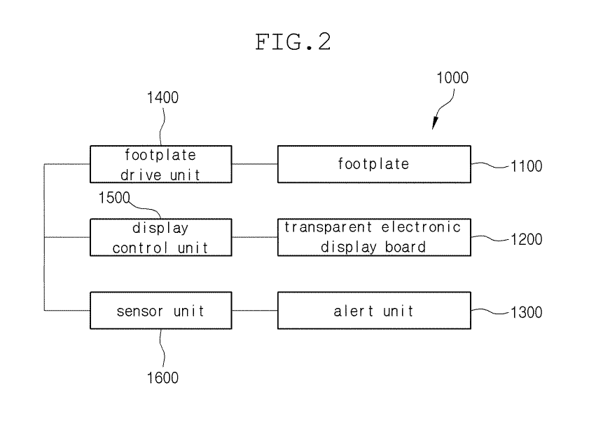

FIG. 1 is a perspective view illustrating a moving walkway having a transparent electronic display board according to the present invention. FIG. 2 is a block diagram illustrating the moving walkway having the transparent electronic display board according to the present invention.

Referring to FIGS. 1 and 2, the moving walkway according to the present invention includes one or more footplates 1100, a footplate drive unit 1400, transparent electronic display boards 1200, a display control unit 1500, a sensor unit 1600, and an alert unit 1300. The footplates 1100 are connected to each other in one direction and move in a circulating manner. The footplate drive unit 1400 drives the footplates 1100. The transparent electronic display boards 1200 are installed upright on opposite sides of the footplates 1100. The display control unit 1500 controls the transparent electronic display boards 1200. The sensor unit 1600 detects whether the footplates 1100 malfunction. The alert unit 1300 announces the malfunction of the footplates 1100 in response to the result of the detection of the sensor unit 1600.

The footplates 1100, each of which is planar, are successively connected to each other to extend a predetermined length and are rotated in one direction. Each footplate 1100 has a sufficient width to allow a pedestrian to board the moving walkway. The multiple footplates 1100 are connected to each other such that they rotate and circulate between a departure place and a destination place.

The footplate drive unit 1400 provides driving force for rotating the footplates 1100. For example, the footplate drive unit 1400 drives a drive motor (not shown) in response to a drive signal transmitted from an operating panel (not shown) and thus rotates the footplates 1100. The footplates 1100 and the footplate drive unit 1400 are embodied by techniques known in this art, and further explanation thereof is thus deemed unnecessary.

The sensor unit 1600 senses whether the footplates 1100 are operated and applies a malfunction sensing signal to the alert unit 1300 when needed. For instance, when the rotation of the footplates 1100 is interrupted by a foreign substance caught between the footplates 1100 or other malfunction of the footplates 1100, the sensor unit 1600 detects the interruption of the operation of the footplates 1100 and operates the alert unit 1300. Furthermore, the sensor unit 1600 may sense whether a pedestrian is present on the footplates 1100 and transmit an on or off signal to the footplate drive unit 1400. In other words, the sensor unit 1600 transmits an off signal to the footplate drive unit 1400 when there is no pedestrian on the footplates 1100. The sensor unit 1600 transmits an on signal to the footplate drive unit 1400 when it senses that there is a pedestrian on the footplates 1100.

The display control unit 1500 determines whether to output information that has been stored or is received via telecommunications and then controls transparent electronic display boards 1200 such that the information is output on the transparent electronic display boards 1200 when needed. Information output on the transparent electronic display board 1200 may include information for promotion of a product, information about takeoff or landing times of airplanes or delay in arrival or departure of airplanes, or weather information.

The transparent electronic display boards 1200 are provided on opposite sides of the footplates 1100. A support panel (not designated by a reference numeral) is installed on the upper surface of each transparent electronic display board 1200 so that a user can lean on the transparent electronic display board 1200. The transparent electronic display board 1200 is fixed upright under the support panel and outputs an image or video for advertising or information about the use of an airport (e.g., information about delay in arrival or departure of airplanes, takeoff or landing times of airplanes, or weather information). The transparent electronic display board 1200 can output various kinds of information under the control of the display control unit 1500. Here, the transparent electronic display board 1200 may use texts, symbols, or videos to output various kinds of information. Furthermore, the transparent electronic display board 1200 is preferably configured such that drive voltage can be uniformly applied to a plurality of light-emitting elements, so that the light-emitting elements can emit light of uniform intensity. Thus, the transparent electronic display board 1200 can provide images of high quality. This will be described in more detail later herein with reference to the attached drawings.

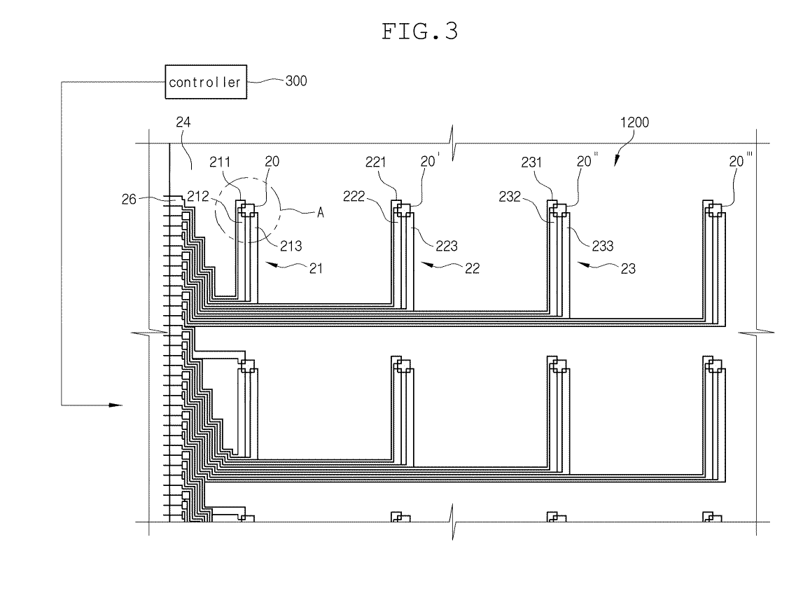

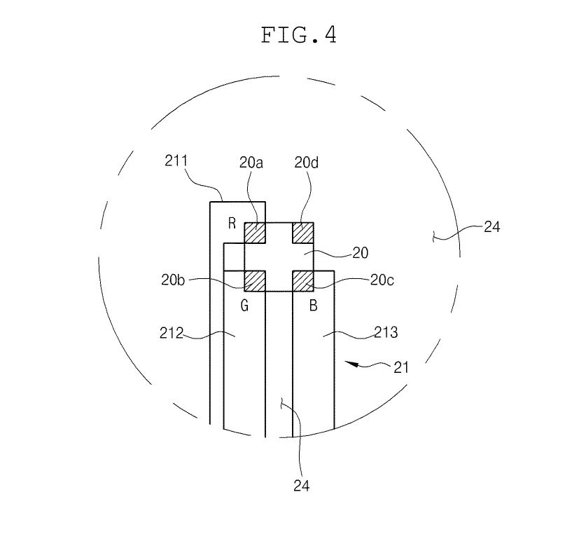

FIG. 3 is a view showing the transparent electronic display board of the moving walkway according to the present invention. FIG. 4 is a view showing an enlargement of a light-emitting element of the transparent electronic display board of the moving walkway according to the present invention.

Referring to FIGS. 3 and 4, the transparent electronic display board 1200 includes a pair of transparent plates 10, transparent electrodes 21, a plurality of light-emitting elements 20, 20′, 20″, and 20′″, a controller 30, and a transparent-electrode conductive tape 25. The transparent plates 10 are spaced apart from each other and are adhered to each other by transparent resin. The transparent electrodes 21 through 24 are made of conductive material and are provided on either of the transparent plates 10 so as to conduct electricity. The light-emitting elements 20, 20′, 20″, 20′″ are fixed on either side of the transparent plates 10 and emit light by means of power applied thereto from the transparent electrodes 21 through 24. The controller 30 controls the turning on or off of the light-emitting elements 20. Power is supplied to the transparent electrodes 21 through 24 through the transparent-electrode conductive tape 25.

In this embodiment, the two transparent plates 10 are disposed facing each other and are adhered to each other by transparent resin charged into the space between the two transparent plates 10. Each transparent plate 10 may be made of any one selected from among transparent glass, acryl and polycarbonate. The coupling of the light-emitting elements 20 to the transparent plate 10 can be embodied by a well-known technique, and thus further explanation thereof will be omitted.

Each light-emitting element 20 is a light source, which emits light in response to the supply of power. The multiple light-emitting elements 20 are fixed, by conductive resin (not shown), on the respective transparent electrodes 21, 22, and 23, which are formed on the surface of either of the two transparent plates 10. The lower end of each light-emitting element 20 is fixed to the transparent electrodes 21, 22 and 23. The upper portion of the light-emitting element 20 is protected by transparent resin and is adhered to the other transparent plate. Each light-emitting element 20 has anode electrodes 20a through 20c and a cathode electrode 20d. Positive power is input into or output from the anode electrodes 20a, 20b and 20c. Negative power is input into or output from the cathode electrode 20d. Furthermore, each light-emitting element 20 may comprise any one of a two-electrode light-emitting element having one anode electrode and one cathode electrode, a three-electrode light-emitting element having two anode electrodes and one cathode electrode, and a four-electrode light-emitting element having three anode electrodes and one cathode electrode. In the present invention, the use of a four-electrode light-emitting element will be illustrated by way of example.

The transparent electrodes 21 through 24 are formed by applying any one of ITO (Indium Tin Oxide), IZO (Indium Zinc Oxide) and liquid polymer, which are conductive materials, to the surface of the transparent plate that faces the other transparent plate. The transparent electrodes 21 through 24 form one or more connection patterns 21 through 24 that are partitioned and separated from each other such that they are insulated from each other and are respectively connected to the anode electrodes 20a, 20b and 20c and to the cathode electrode 20d of the light-emitting element 20. Each of the connection patterns 21 through 24 extends a predetermined length so that it can electrically transmit a signal to the light-emitting element.

The partitioned transparent electrodes 21 through 24 are respectively connected to the anode electrodes 20a, 20b, and 20c and the cathode electrode 20d of the light-emitting element 20. The transparent electrodes 21 through 24 function to transmit control signals from the controller 30 to the light-emitting element 20. With regard to the transparent electrodes 21 through 24, areas partitioned to be connected to the anode electrodes 20a, 20b, and 20c of the light-emitting element are respectively called the connection patterns 21 through 23, and the area partitioned to be connected to the cathode electrode 20d is called the cathode connection pattern 24.

In detail, the transparent electrodes 21, 22, 23, and 24 comprise a plurality of groups of transparent electrodes 21, 22, 23, and 24. Each group of transparent electrodes 21, 22, 23, 24 includes: one or more connection patterns 21 through 23, which are respectively connected to the one or more anode electrodes 20a, 20b, and 20c formed on the single light-emitting element 20; and a cathode connection pattern 24, connected to the cathode electrode 20d.

The number of connection patterns 21 through 23 corresponds to the number of anode electrodes 20a, 20b, and 20c of each light-emitting element 20; however, a single cathode connection pattern 24 is connected in common to the cathode electrodes 20d of a plurality of light-emitting elements 20.

For example, for a four-electrode light-emitting element 20, the transparent electrodes 21 through 24 comprise a plurality of groups, each of which includes first through third connection patterns 21 through 23, which are respectively connected to first through third anode electrodes 20a, 20b, and 20c.

A first group of connection patterns includes a first connection pattern 211 connected to the first anode electrode 20a of the first light-emitting element 20, a second connection pattern 212 connected to the second anode electrode 20b, and a third connection pattern 23 connected to the third anode electrode 20c.

Likewise, a second group of connection patterns 22 and a third group of connection patterns 23 respectively include first through third connection patterns 221, 222, and 223 and first through third connection patterns 231, 232, and 233, which are respectively connected to the anode electrodes of the second and third light-emitting elements 20′ and 20″.

However, the cathode connection electrode 24 is used in common. In other words, it is connected in common to the cathode electrodes 20d formed on the respective light-emitting elements 20.

That is, a single cathode connection pattern 24 is connected in common to the cathode electrodes 20d of the light-emitting elements 20 provided on the transparent electronic display board 1200, and the connection patterns 21 through 23 are respectively provided on the anode electrodes 20a, 20b, and 20c of each light-emitting element 20.

The multiple groups of connection patterns 21 to 23 extend from an end of a first side of the transparent plate 10 toward a second side thereof and are connected to the corresponding light-emitting elements, which are arranged in the lateral direction. The length to which each group of connection patterns 21, 22, 23 extends is changed depending on the location of the corresponding light-emitting element 20, 20′, 20″. Depending on the length and on the resistance per unit area, the width of each connection pattern 21, 22, 23 may be changed. The reason for this is to maintain the intensity of light, emitted from the light-emitting elements provided on the transparent electronic display board 1200, uniform. This will be described in detail later herein.

The transparent-electrode conductive tape 25 is attached to each connection terminal of the connection patterns 21 through 23.

Furthermore, the transparent conductive tape 25 is adhered to the start point of each connection pattern 21, 22, 23.

That is, in the transparent electronic display board 1200, the connection terminals 26 connected to the transparent conductive tape 25 are arranged in such a way that the cathode connection pattern 24 and the groups of connection patterns 21 to 23 successively extend from at least one of upper, lower, left and right edges of the transparent plates 10.

Of the connection terminals 26, the connection terminal that is connected to the cathode connection pattern 24 is formed at the uppermost position. The connection terminals 26 of the connection patterns 211 through 233 corresponding to the groups of connection patterns 21 through 23 connected to one or more anodes are successively provided below the connection terminal of the cathode connection pattern 24.

The connection patterns 211 through 233 of the groups 21 through 23 are connected to one or more anode electrodes of the corresponding light-emitting elements 20, 20′, and 201′. At least one of the connection patterns is spaced apart from the other connection patterns by the cathode connection pattern 24 disposed therebetween and is connected to the corresponding anode electrode 20a, 20b, 20c (refer to the second and third connection patterns 212 and 213 of FIG. 4).

The connection patterns 211 through 233 of the groups 21 to 23 extend from the transparent-electrode conductive tape 25 and are respectively connected to the anode electrodes 20a, 20b, and 20c of the corresponding light-emitting elements 20. The cathode connection pattern 24 corresponds to the entire area other than the areas on which the connection patterns 211 through 233 are formed.

Furthermore, in order to solve the conventional problem in which the intensities of light output from the light-emitting elements 20, 20′, and 20″ are not uniform because of differences in length and resistance per unit area of the connection patterns 211 through 233, the present invention is configured such that the widths of the connection patterns 211 through 233 connected to the anode electrodes of the light-emitting elements 20, 20′, and 20″ are successively increased depending on the sheet resistances and lengths thereof. This will be described in more detail later herein.

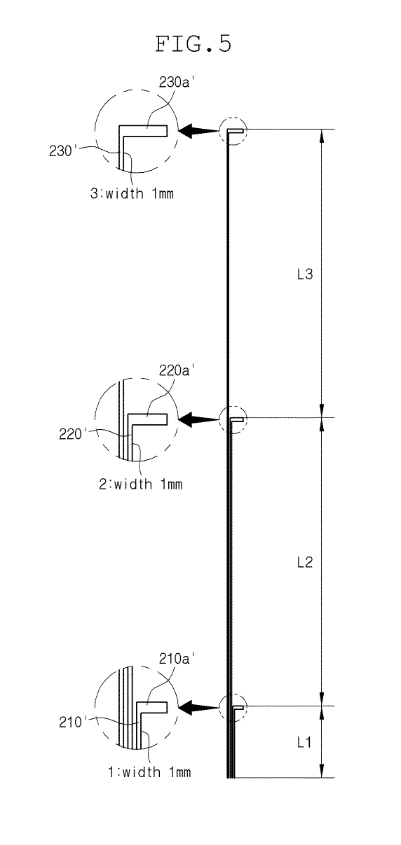

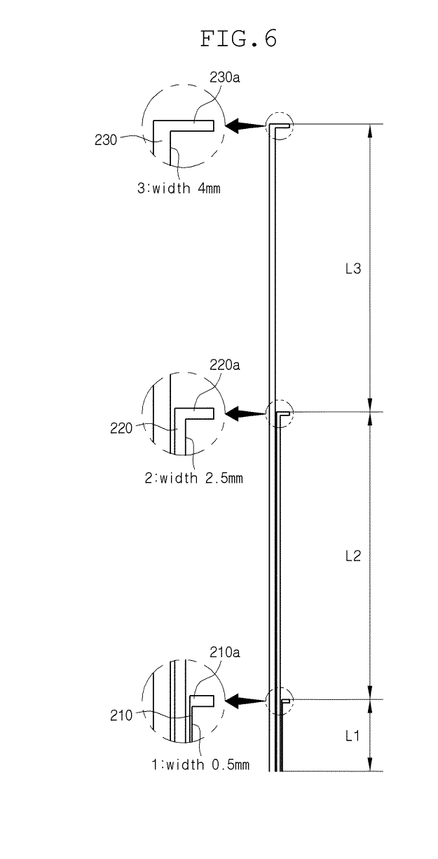

FIG. 5 is a view showing a first comparative example of the transparent electronic display board of the moving walkway according to the present invention. FIG. 6 is a view showing a first experimental example of the transparent electronic display board of the moving walkway according to the present invention.

The first comparative example and the first experimental example respectively include connection patterns 211 through 233 and 211′ through 233′ of first through third groups 210 through 230 and 210′ through 230′. The connection patterns 211 through 233 or 211′ through 233′ are respectively connected to the first through third light-emitting elements 20, 20′, and 20″. The first through third groups 210 through 230 respectively refer to the groups of connection patterns 21 through 23 connected to the respective light-emitting elements. In FIGS. 5 and 6, each group is illustrated as being formed by a single pattern.

Furthermore, the first through third light-emitting elements connected to the ends of the first through third connection patterns are not shown in FIGS. 5 and 6.

Each of the first experimental example and the first comparative example includes the first group 210′, 210 connected to the first light-emitting element 20, the second group 220′, 220 connected to the second light-emitting element 20′, and the third group 230, 230′ connected to the third light-emitting element 20″. The groups extend different lengths L1, L2, and L3.

Further, in the first experimental example, the widths of the connection patterns 211 through 233 of the groups 210 through 230 are successively increased depending on the lengths by which the connection patterns 211 through 233 extend. In the first comparative example, the connection patterns 211′ through 233′ have the same width regardless of the lengths by which they extend.

The first through third groups 210, 210′, 220, 220′, 230, and 230′ are configured such that coupling ends 210a, 210a′ 210b, 210b′, 210c, and 210c′ are horizontally bent from the ends of the connection patterns 211 through 233 and 211′ through 233′ and are adhered to one or more corresponding electrodes 20a through 20c formed on the light-emitting elements 20, 20′, and 20″.

In the first experimental example and the first comparative example, current values applied to the light-emitting elements 20, 20′, and 20″ were measured on the coupling ends 210a, 210a′, 210b, 210b′, 210c, and 210c′. Furthermore, variation in current attributable to variation in width, which is the result of an increase in length, was measured and compared between the first experimental example and the first comparative example. The current value is calculated using the following equations 1 and 2.

L (mm)/W (mm)×sheet resistance (Ω) of transparent electrode=resistance (Ω) of etched area (Equation 1)

V/resistance (kΩ) of etched area=I (mA) (Equation 2)

Here, L denotes the length of a connection pattern. W denotes the width of the connection pattern. The sheet resistance of the transparent electrode refers to the sheet resistance of the transparent electrode itself. V denotes the rated voltage. I denotes the current value applied from the connection pattern to the corresponding light-emitting element (hereinafter, referred to as the drive current of the light-emitting element). The resistance of the etched area refers to the resistance per unit area of the connection pattern formed by etching on the transparent electrode.

The sheet resistance of the transparent electrode may be changed depending on, for example, the manufacturer, product specifications, or the like. For products mainly used in this industry, the sheet resistance is 14 Ω.

Therefore, in the present invention, the drive currents applied to the first through third light-emitting elements 20, 20′, and 20″ are controlled to be maintained in a predetermined range by adjusting the widths or lengths of the connection patterns, whereby the outputs of the first through third light-emitting elements 20, 20′, and 20″ can be made uniform.

As stated above, in the present invention, the drive currents applied to the light-emitting elements 20, 20′, and 20″ may be controlled by adjusting the widths of the connection patterns 211 through 233. Alternatively, depending on the application of a designer or a user, the drive currents applied to the light-emitting elements 20, 20′, and 20″ may be controlled by adjusting the lengths of the connection patterns. Adjusting the widths or lengths of the connection patterns to make the drive currents uniform is only one of various examples falling within the bounds of the technical spirit of the present invention.

Hereinbelow, the operation and effect realized by the technical spirit of the present invention will be explained by comparing experimental data, proving the uniformity of drive currents of different widths of the connection patterns, with drive currents of the conventional technique.

Table 1 shows drive current data measured in the first comparative example. Here, the rated voltage was 12 V, and the same products having a reference current of 5 mA were used as the first through third light-emitting elements 20, 20′, and 20″.

The drive currents were obtained by measuring currents applied to the coupling ends connected to the electrodes of the light-emitting elements 20, 20′, and 20″. The sheet resistance of the transparent electrodes was set as 14Ω, and the rated voltage was set as 12 V. The same voltage was applied to the connection patterns.

TABLE 1

| | First | | Second | |
|---|---|---|---|---|
| | etched area | | etched area | |
| Connection | resistance | First drive | resistance | Second drive |
| pattern | (theoretical | current | (theoretical | current |
| No. | value, kΩ) | (mA) | value, kΩ) | (mA) |
| 1 | 0.76 | 15.79 | 0.71 | 13.31 |
| 2 | 3.57 | 3.36 | 3.77 | 2.77 |
| 3 | 6.39 | 1.88 | 6.85 | 1.56 |

The first drive currents are current values on the coupling ends 210a′ through 230a′ of the respective connection patterns, calculated by the first etched area resistances obtained from the product specifications. The second drive currents are values which were actually measured on the coupling ends 210a′ through 230a′ of the connection patterns of the first through third groups 210′ through 230′. With regard to the connection patterns 211′ and 233′ of the first through third groups 210′ through 230′, the connection patterns 211′ through 213′ of the first group 210′ are the shortest, while the connection patterns 231′ through 233′ of the third group 230′ are the longest. However, the connection patterns 211′ and 233′ are the same in width.

It was observed that, under the above-mentioned conditions, the maximum deviation in current measured on the coupling ends 210a′ through 230a′, which was caused by the difference in length of the connection patterns, was 12 mA.

Table 2 shows data about drive currents measured in the first experimental example. Here, the lengths L1, L2, and L3 of the connection patterns of the first experimental example are respectively the same as the lengths L1, L2, L3 of the connection patterns of the first comparative example. However, the connection patterns of the first experimental example are configured such that as the length thereof is increased, the width thereof is also increased. With regard to experimental conditions, the rated voltage was set as 12 V, and the reference current of the light-emitting elements was 5 mA. Products having the same specifications as that of the first comparative example were used.

Furthermore, the width of the connection patterns 211 through 213 of the first group 210 was 0.5 mm, the width of the connection patterns 221 through 223 of the second group 220 was 2.5 mm, and the width of the connection patterns 231 through 233 of the second group 230 was 4 mm. As such, as the lengths L1, L2, and L3 of the connection patterns were increased, the widths thereof were also increased.

TABLE 2

| | First | | Second | |
|---|---|---|---|---|
| | etched area | | etched area | |
| Connection | resistance | First drive | resistance | Second drive |
| pattern | (theoretical | current | (theoretical | current |
| No. | value, kΩ) | (mA) | value, kΩ) | (mA) |
| 1 | 1.42 | 8.45 | 1.28 | 6.80 |
| 2 | 1.44 | 8.33 | 1.28 | 6.83 |
| 3 | 1.64 | 7.32 | 1.46 | 6.00 |

Checking the drive currents given in Table 2, it can be understood that with regard to the first drive currents or the second drive currents, the maximum deviation between values measured on the coupling ends 210a and 230a of the connection patterns 211 and 213 of the first group 210 or the connection patterns 231 and 233 of the third group 230 is less than 1.2 mA.

In other words, drive currents applied to the light-emitting elements 20, 20′, and 20″, forming the coupling ends 210a through 230a of the connection patterns of the groups 210, 220, 230, are increased as the connection patterns are increased in width. Thus, unlike the data of Table 1, it can be understood that the loss of current resulting from the increase in length of the connection patterns 211 through 233 can be compensated for.

Furthermore, the applicant of the present invention used a transparent electronic display board 1200 with four-terminal light-emitting elements, each of which is designed such that each group includes four connection patterns, and made a comparison using a second comparative example in which connection patterns have the same width as a second experimental example, in which the widths of connection patterns are successively increased.

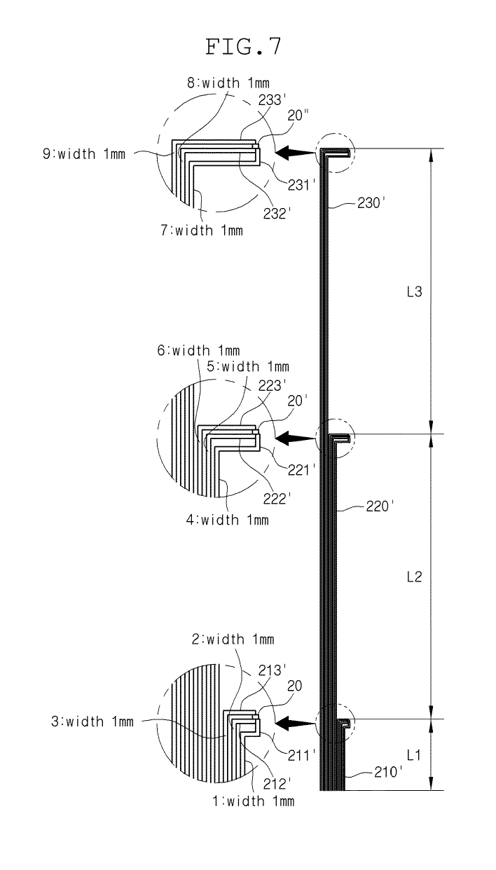

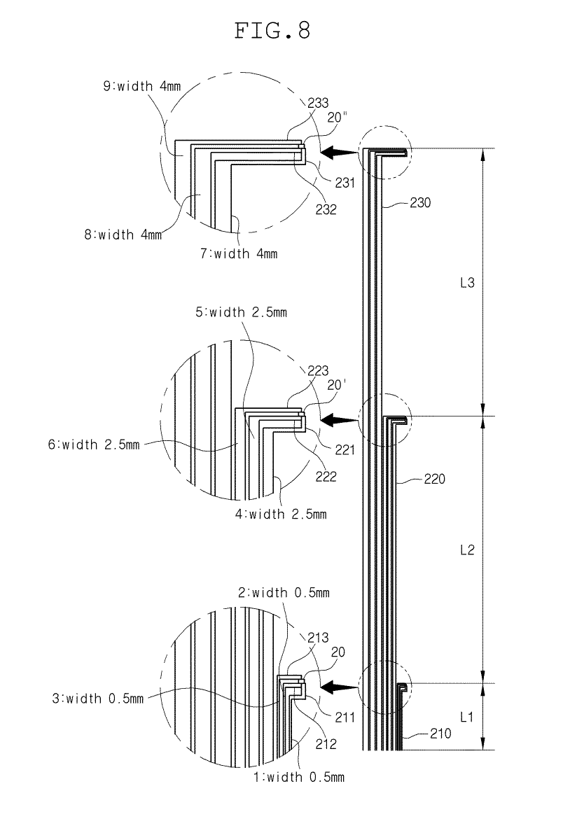

FIG. 7 is a view showing a second comparative example of the transparent electronic display board of the moving walkway according to the present invention. FIG. 8 is a view showing a second experimental example of the transparent electronic display board of the moving walkway according to the present invention.

Referring to FIG. 7, the second comparative example includes one or more groups 21 through 23 and one or more light-emitting elements 20, 20′, and 20″. The groups 21 through 23 include one or more connection patterns 211 through 233 which are formed by etching on transparent electrodes 21 through 24, which are formed by applying conductive material to one surface of a transparent plate 10. The light-emitting elements 20, 20′, and 20″ emit light by means of power applied from the connection patterns 211 through 233.

A light-emitting element having a four-terminal electrode is used as each light-emitting element 20, 20′, 20″. As stated above, the cathode electrodes of the light-emitting elements are connected in common to the cathode connection pattern 24.

The groups 210′ through 230′ including the one or more connection patterns 211′ through 233′ are successively increased in length. The groups 210′ through 230′ include first through third connection patterns 211′ through 233′ connected to the anode electrodes of the light-emitting element 20, 20′, and 20″.

The connection patterns 211′ through 233′ of the first through third groups 210′ through 230′ have the same width of 1 mm and are successively increased in length from the first group 210′ to the third group 230′. The first group 210′ includes first through third connection patterns 211′ through 213′, which are connected to respective electrodes of the first light-emitting element 20. The second group 220′ includes fourth through sixth connection patterns 221′ through 223′, which are connected to respective electrodes of the second light-emitting element 20′. The third group 230′ includes seventh through ninth connection patterns 231′ through 233′, which are connected to respective electrodes of the third light-emitting element 20″. Here, the first through ninth connection patterns 211′ through 233′ have the same width but have different lengths depending on the group. Data measured in the second comparative example is as follows.

TABLE 3

| | First | | Second | |
|---|---|---|---|---|
| | etched area | | etched area | |
| Connection | resistance | First drive | resistance | Second drive |
| pattern | (theoretical | current | (theoretical | current |
| No. | value, kΩ) | (mA) | value, kΩ) | (mA) |
| 1 | 0.77 | 15.58 | 0.72 | 13.43 |
| 2 | 0.78 | 15.38 | 0.74 | 12.03 |
| 3 | 0.83 | 14.36 | 0.80 | 11.46 |
| 4 | 3.66 | 3.28 | 3.83 | 2.73 |
| 5 | 3.66 | 3.28 | 3.86 | 2.51 |
| 6 | 3.71 | 3.23 | 3.92 | 2.43 |
| 7 | 6.54 | 1.83 | 7.02 | 1.48 |
| 8 | 6.55 | 1.83 | 7.01 | 1.36 |
| 9 | 6.60 | 1.82 | 7.06 | 1.37 |

The rated voltage was 12 V, the reference current was 5 mA, and the sheet resistance of the transparent electrode was 14Ω. Each drive current was measured by the connection patterns.

From Table 3, it can be understood that as the length of the pattern is increased, the etched area resistance is increased by the maximum of 5.9, and the maximum deviation of the drive current is 13.76 mA. That is, in the second comparative example, depending on the length of the connection pattern, the intensity of light output from the light-emitting elements 20, 20′, and 20″ varies. Thus, the overall light output of the transparent electronic display board 1200 is not uniform, so that it can be concluded that it is difficult to realize a detailed video.

Meanwhile, the second experimental example of FIG. 8 was tested under the same conditions to compare it with the test result of the second comparative example. Table 4 shows the drive currents measured in the second experimental example. In the second experimental example according to the present invention, the lengths of the connection patterns and the rated voltage were the same as those of the second comparative example, and light-emitting elements and transparent electrodes having the same specifications as those of the second comparative example were used. However, unlike the second comparative example, the connection patterns of the first through third groups 210 through 230 were successively increased in width.

The width of the connection patterns 211 through 213 of the first group 210 was 0.5 mm, the width of the connection patterns 221 through 223 of the second group 220 was 2.5 mm, and the width of the connection patterns 231 through 233 of the second group 230 was 4 mm. The lengths L1, L2, and L3 of the connection patterns were the same as those of the second comparative example, the sheet resistance of the transparent electrodes was 14Ω, and the rated voltage was 12 V.

TABLE 4

| | First | | Second | |
|---|---|---|---|---|
| | etched area | | etched area | |
| Connection | resistance | First drive | resistance | Second drive |
| pattern | (theoretical | current | (theoretical | current |
| No. | value, kΩ) | (mA) | value, kΩ) | (mA) |
| 1 | 1.39 | 8.63 | 1.22 | 6.92 |
| 2 | 1.44 | 8.33 | 1.31 | 5.86 |
| 3 | 1.52 | 7.89 | 1.37 | 5.52 |
| 4 | 1.56 | 7.70 | 1.36 | 6.41 |
| 5 | 1.55 | 7.74 | 1.37 | 5.76 |
| 6 | 1.61 | 7.45 | 1.42 | 5.49 |
| 7 | 1.87 | 6.42 | 1.76 | 5.16 |
| 8 | 1.90 | 6.31 | 1.69 | 4.56 |
| 9 | 1.98 | 6.06 | 1.58 | 4.49 |

The first drive currents of Table 4, which are theoretical current values obtained from the product specifications, were calculated from Equations 1 and 2. The second drive currents are actually measured data. The widths of the connection patterns 211 through 233 of the first through third groups 210 through 230 were calculated from Equations 1 and 2.

The maximum deviation of the first or second drive currents was 2.53 mA, which was markedly less than 13.76 mA of the second comparative example. That is, in the present invention, the deviation of the light outputs of the light-emitting elements 20, 20′, and 20″ is comparatively small regardless of the lengths of the connection patterns 211 through 233. Therefore, the entire transparent electronic display board 1200 can uniformly emit light.

As described above, in the transparent electronic display boards 1200 provided upright on the opposite sides of the footplates of the moving walkway 1000, the light-emitting elements can emit light with uniform light output. Therefore, the transparent electronic display boards 1200 can embody more precise and clean high-quality images or videos.

### INDUSTRIAL APPLICABILITY

In the present invention, a transparent electronic display board that can output images or videos is installed on a moving walkway, thus making it possible for a pedestrian who moves on the moving walkway to relieve tedium. Furthermore, the transparent electronic display board can provide information, for example, boarding information in an airport, thereby improving user convenience. Therefore, the present invention can be regarded as being very useful.

1. A moving walkway having a transparent electronic display board, the moving walkway comprising:
a plurality of footplates connected to each other and configured to move in one direction; and
transparent electronic display boards installed on respective opposite sides of the footplates, with a support panel installed on an upper surface of each of the transparent electronic display boards, each of the transparent electronic display boards being fixed under the corresponding support panel and outputting a picture including a text, a symbol, an image, or a video,
wherein each of the transparent electronic display boards comprises:
one or more light-emitting elements fixed on at least one surface of transparent plates, the transparent plates being spaced apart from each other and adhered to each other by transparent resin charged into a space between the transparent plates;
transparent electrodes formed by conductive material applied to the transparent plates, the transparent electrodes applying power to the light-emitting elements; and
connection patterns extending different lengths from the transparent electrodes and transmitting electrical signals to the light-emitting elements,
wherein widths of the connection patterns are increased as lengths of the connection patterns connected to the light-emitting elements are increased.

2. The moving walkway of claim 1, wherein the width of each of the connection patterns is calculated from Equations 1 and 2,
L (mm)/W (mm)×sheet resistance (Ω) of transparent electrode=resistance (Ω) of etched area (Equation 1)
rated voltage (V)/resistance (kΩ) of etched area=I (mA) (Equation 2)
where, L denotes the length of the connection pattern, W denotes the width of the connection pattern, the sheet resistance of the transparent electrode refers to a sheet resistance of the transparent electrode itself, the rated voltage is a voltage applied to the transparent electronic display board, I denotes a current applied from the connection pattern to the light-emitting element, and the resistance of the etched area denotes a resistance per unit area of the connection pattern formed by etching on the transparent electrode.

3. The moving walkway of claim 1, wherein the light-emitting element comprises:
one or more anode electrodes and a cathode electrode that are connected to the respective connection patterns,
wherein the connection patterns comprise: one or more connection patterns formed by etching on the transparent electrodes and connected to the respective anode electrodes; and a cathode connection pattern connected in common to cathode electrodes formed on the respective light-emitting elements.

4. The moving walkway of claim 3, wherein in each of the transparent electronic display boards,
the cathode connection pattern and the connection patterns respectively comprise connection terminals successively extending from at least one of upper, lower, left and right edges of the transparent plates, the connection terminals being connected to transparent conductive tape,
of the connection terminals, the connection terminal of the cathode connection electrode is disposed at an uppermost position, and
the connection terminals of the connection patterns are successively disposed below the connection terminal of the cathode connection pattern.

5. The moving walkway of claim 3, wherein the connection patterns are respectively connected to the anode electrodes of each of the light-emitting elements, wherein at least one of the connection patterns is spaced apart from another of the connection patterns by the cathode connection pattern disposed therebetween.

6. The moving walkway of claim 3, wherein the light-emitting elements are arranged in a horizontal or vertical direction,
wherein for each of the light-emitting elements, a number of connection patterns is equal to a number of anode electrodes of the light-emitting element.
